(19) United States
(12) Patent Application Publication
(10) Pub. No.: US 2006/0045816 A1
(43) Pub. Date: Mar. 2, 2006

(54) Apparatus and method for mixing and supplying chemicals

(76) Inventors: Soo-III Jang, Cheonan-si (KR); Kwang-II Choi, Cheonan-shi (KR); Joon-Hyun Cho, Cheonan-si (KR)

Correspondence Address: HARNESS, DICKEY & PIERCE, P.L.C., P.O. BOX 8910, RESTON, VA, 20195, US

(21) Appl. No.: 11/133,408

(22) Filed: May 20, 2005

(30) Foreign Application Priority Data
Sep. 2, 2004 (KR) 2004-69931

(51) Int. Cl. B32B 27/04; F01N 3/20

(52) U.S. Cl. 422/110; 422/105

(57) ABSTRACT

The present invention is directed to apparatus and method for mixing at least two chemicals and supplying the mixture to a substrate treating apparatus for treating substrates using a mixture. The apparatus includes at least two chemical source sections; transfer lines connected to the chemical source sections respectively; a mina transfer line connected to the transfer lines and configured for mixing chemicals transferred from the transfer line and transferring the mixture to the treating apparatus; detectors for detecting flow rates of the chemicals transferred to the transfer lines respectively; and a control member for comparing flow rate data received from the detectors to control flow rates of chemicals.

### PRIORITY STATEMENT

This application claims priority of Korean Patent Application No. 2004-69931, filed on Sep. 2, 2004 in the Korean Intellectual Property Office, the disclosure of which is incorporated herein in its entirety by reference.

### BACKGROUND OF THE INVENTION

1. Field of the Invention

The present invention relates to apparatus and method for mixing at least two chemicals in determined mixing ratios and supplying the mixture in real time.

2. Description of Related Art

Generally, a mixture of a chemical and deionized water (DI water) or at least two chemicals is used in a wet etch for removing a wafer surface and a cleaning process.

In a conventional chemical supply apparatus for mixing a chemical and DI water in a determined mixing ratio and supplying the mixture to a treating apparatus, chemicals are supplied to a mixing tank in determined their quantities, respectively. Supplying the chemicals is done by an integrating flowmeter installed at a transfer line, a control unit, and a shutoff valve opened/closed by the control unit. Namely, if a mixing ratio of A chemical to B chemical is 1:2 and a mixture of 300 liters is required, the chemical A and B are accumulated using an integrating flowmeter until their quantities reach 100 liters and 200 liters, respectively and the mixture of 300 liters is transferred to a buffer tank to be supplied to a treating apparatus.

Generally, a conventional apparatuses does not support real-time mixture and supply of chemicals and has a complex configuration of two tanks and circulating lines connected with the tanks. Thus, lots of time and an extra install space are required and a chemical mixing and supply procedure becomes complex.

### SUMMARY OF THE INVENTION

Exemplary embodiments of the present invention provide apparatus and method for mixing at least two chemicals and supplying the mixture in real time. In an exemplary embodiment, the apparatus includes at least two chemical source sections; transfer lines connected to the chemical source sections respectively; a mina transfer line connected to the transfer lines and configured for mixing chemicals transferred from the transfer line and transferring the mixture to the treating apparatus; detectors for detecting flow rates of the chemicals transferred to the transfer lines respectively; and a control member for comparing flow rate data received from the detectors to control flow rates of chemicals.

In some embodiments of the present invention, the control member includes flow rate control valves mounted on the transfer lines respectively and disposed in front of the detector; and a controller for receiving flow rate data from the detectors to, based on a flow rate of one of the chemicals, calculate a mixing ratio of the other chemicals and comparing the calculated mixing ratio with a preset mixing ratio to output a control signal for controlling open rates of the flow rate control valve.

In some embodiments of the present invention, the apparatus further includes a drain line connected to the respective transfer lines for draining an initially flowing chemical of an irregular flow rate.

In some embodiments of the present invention, the controller is a PID controller.

In an exemplary embodiment, the method includes setting a mixing ratio of at least tow chemicals; transferring chemicals to a treating apparatus through transfer lines connected to chemical source sections respectively; detecting flow rates of the chemicals transferred to the transfer lines respectively; and comparing the detected flow rate data with a preset mixing ratio of chemicals to control flow rates of the chemicals.

In some embodiments of the present invention, controlling the flow rates of the chemicals includes based on a flow rate of one of the chemicals, calculating a mixing ratio of the other chemicals; comparing the calculated mixing ratio with a preset mixing ratio; and controlling open rates of flow rate control valves mounted on the transfer lines respectively depending on the comparing result.

In some embodiments of the present invention, controlling the flow rates of the chemicals includes based on a flow rate of one of the chemicals, calculating a mixing ratio of the other chemicals; comparing the calculated mixing ratio with a preset mixing ratio; and controlling open rates of flow rate control valves mounted on transfer lines corresponding to the other chemicals to control flow rates of the other chemicals depending on the comparing result.

In some embodiments of the present invention, the method further includes draining initially transferred chemicals through the transfer line for a predetermined time.

In some embodiments of the present invention, in the detection of the chemical flow rate, a chemical flow rate is detected since the chemical is transferred.

### BRIEF DESCRIPTION OF THE DRAWINGS

FIG. 1 is a configuration diagram of a chemical mixing and supply apparatus according to the present invention.

FIG. 2 is a flowchart for explaining a chemical mixing and supply method according to the present invention.

FIG. 3 is a configuration diagram of a buffer tank added to the chemical mixing and supply apparatus shown in FIG. 1.

### DETAILED DESCRIPTION OF THE INVENTION

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the height of layers and regions are exaggerated for clarity. Like numbers refer to like elements throughout.

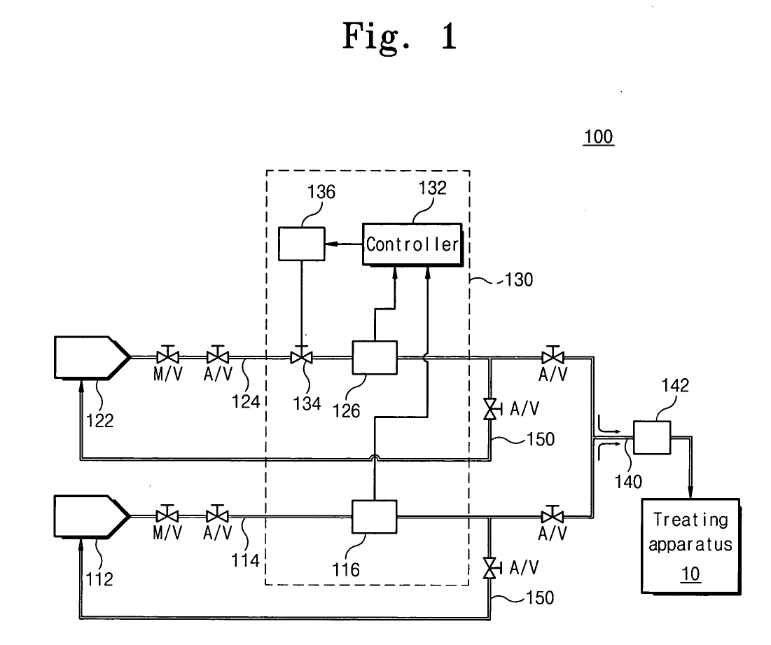

As illustrated in FIG. 1, a chemical mixing and supply apparatus 100 according to the present invention mixes a first chemical with a second chemical in a determined mixing ratio and supplying the mixture to a treating apparatus. The apparatus 100 includes first and second source sections 112 and 122, first and second lines 114 and 124, first and second flowmeters 116 and 126, a control member 130, and a main transfer line 140.

Shutoff valves M/V and A/V and a first flowmeter 116 are mounted on the first transfer line 114. Shutoff valves M/V and A/V, a flow rate control valve, and a second flowmeter 126 are mounted on the second transfer line 124. The first and second transfer lines 114 and 124 are connected to a main transfer line 140. A drain line 150 is connected to the respective rear sides of the first and second transfer lines 114 and 124.

The first flowmeter 116 detects a flow rate of a first chemical flowing to the first transfer line 114, and the second flowmeter 126 detects a flow rate of a second chemical flowing to the second transfer line 124. Electric signals detected from flowmeters are transmitted to a controller 132 of the control member 130. In some embodiments of the invention, a flowmeter may be any noncontact-type measurer.

The control member 130 compares flow data provided from the first and second flowmeters 116 and 126 with a preset mixing ratio of chemicals to control flow rates of the chemicals. The control member 130 includes a flow rate control valve 134 and the controller 132.

The flow rate control valve 134 is mounted on the second transfer line 124 to be in front of the second flowmeter 126. Also the flow rate control valve 134 may be mounted on a first transfer line. The controller 132 receives flow data detected from the first and second flowmeters and calculates a ratio of the second chemical based on the flow rate data of the first chemical. Further, the controller 132 compares the calculated ratio with a preset mixing ratio to output a control signal for controlling an open rate of the flow rate control valve 134 in real time. An air regulator 136 is controlled by the control signal output from the controller 132 and regulates the open rate of the flow rate control valve 134.

The controller 132 sounds an alarm and stops a chemical supply process or takes other actions. Preferably, the controller 132 feebacks a flow rate and adopts, for example, a proportional, proportional-integrate or proportional-integrate-derivative (PID) control scheme. The controller 132 may include a control computer of an apparatus configured for controlling an entire treating operation of a treating process. Additionally, the control computer may be a monitor allowing an operator to watch a flow rate control procedure.

The above-described apparatus is configured for mixing chemicals in a preset mixing ratio and supplying the mixture in real time.

A drain line 150 is connected to the respective first and second transfer lines 114 and 124. Since an initially transferred chemical has a very irregular flow rate, it is drained through the drain line 150 for 3-5 seconds. Thereafter, a regular flow rate is maintained. That is, chemicals are drained in case of hunting in a flow rate. The drain line 150 may be connected to a chemical source section.

The first and second chemicals having a flow rate controlled based on a preset mixing ratio by the control member 130 are supplied to the treating apparatus 10 through the main transfer line 140. For example, a mixer 142 may be mounted on the main transfer line 140 for mixing the first and second chemicals more efficiently in real time.

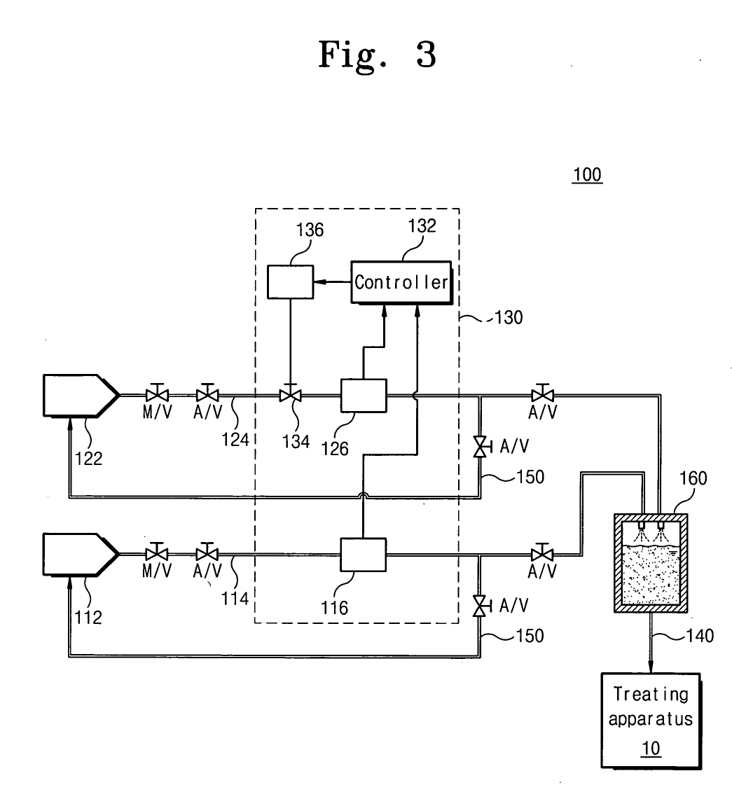

A buffer tank 160 may be installed between the first and second transfer lines 114 and 124 (see FIG. 3) for preventing a chemical backflow resulting from a transfer pressure difference of chemicals transferred through the first and second transfer lines 114 and 124.

Although the apparatus as shown in FIG. 1 mixes and supplies two kinds of chemicals, it may mix and supply at least two kinds of chemicals. Further, transferring chemicals is done by a conventional N₂ pressurizing manner or a conventional pumping manner.

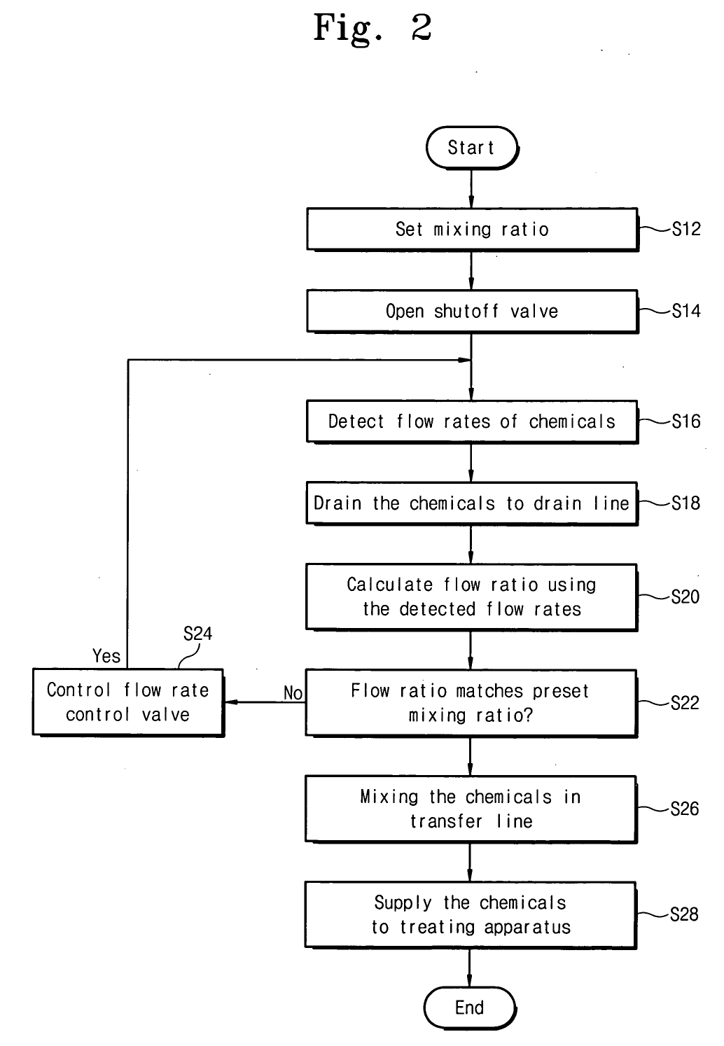

A chemical mixing and supply method will now be described with reference to a flowchart of FIG. 2. A mixing ratio (1:2) of a first chemical to a second chemical is set (S12). Shutoff valves mounted on first and second transfer lines 114 and 124 are opened (S14). Flow rates of the chemicals transferred to the first and second lines 114 and 124 are detected by flowmeters 116 and 126, respectively (S16). The chemicals are drained for a determined time and before their flow rates are controlled based on a preset mixing ratio (S18). Stabilization of the chemical flow rate may be judged using flow rate data detected from first and second flowmeter.

If the flow rates of the chemicals are stabilized, a controller 132 of a control member calculates flow rate data of the second chemical (e.g., 30 m³/s) based on flow rate data of the first chemical (e.g., 10 m³/s) (S20). The controller 132 compares the calculated ratio (1:3) of the first chemical to the second chemical with a preset mixing ratio (1:2) (S22) to output a signal for controlling an open rate of a flow rate control valve 134 mounted on the second transfer line 124 (S24). The flow rate control valve 134 is controlled until a flow rate of the second chemical flowing to the second transfer line 124 reaches 20 m³/s.

When the flow ratio of the first and second chemicals matches the preset mixing ratio, transferring the chemicals to a drain line 150 is stopped and transferring them to a main transfer line 140 starts (S26).

The first and second chemicals are mixed while being transferred to the main transfer line 140, specifically, supplied to a treating apparatus after being mixed in a mixer 142 (S28).

According to the present invention, at least two chemicals are mixed and supplied in real time. Further, a configuration for supplying the determined quantity of chemicals as well as a chemical mixing and supply procedure is simple.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. An apparatus for mixing at least two chemicals and supplying the mixture to a substrate treating apparatus for treating substrates using a mixture, the apparatus comprising:
at least two chemical source sections;
transfer lines connected to the chemical source sections respectively;
a mina transfer line connected to the transfer lines and configured for mixing chemicals transferred from the transfer line and transferring the mixture to the treating apparatus;
detectors for detecting flow rates of the chemicals transferred to the transfer lines respectively; and
a control member for comparing flow rate data received from the detectors to control flow rates of chemicals.

2. The apparatus as recited in claim 1, wherein the control member comprises:
flow rate control valves mounted on the transfer lines respectively and disposed in front of the detector; and
a controller for receiving flow rate data from the detectors to, based on a flow rate of one of the chemicals, calculate a mixing ratio of the other chemicals and comparing the calculated mixing ratio with a preset mixing ratio to output a control signal for controlling open rates of the flow rate control valve.

3. The apparatus as recited in claim 2, further comprising:
a drain line connected to the respective transfer lines for draining an initially flowing chemical of an irregular flow rate.

4. The apparatus as recited in claim 2, wherein the controller is a PID controller.

5. An apparatus for mixing at least two chemicals and supplying the mixture to a substrate treating apparatus using a mixture, the apparatus comprising:
a first chemical source section;
a second chemical source section;
a first transfer line connected to the first chemical source section;
a second transfer line connected to the second chemical source section;
a main transfer line connected to the first and second transfer lines for mixing chemicals transferred from the first and second transfer lines and transferring the mixture to the treating apparatus;
a drain line connected to the respective first and second transfer lines for draining a chemical of an irregular flow rate to prevent the chemical of the irregular flow rate from flowing to the main transfer line;
first and second flowmeters for detecting flow rates of chemicals transferred to the first and second transfer lines respectively; and
a control member for comparing flow data provided from the first and second flowmeters with a preset mixing ratio of chemicals to control flow rates of the chemicals.

6. The apparatus as recited in claim 5, wherein the control member comprises:
a flow rate control valve installed on the second transfer line to be disposed in front of the second flowmeter; and
a controller for receiving flow data detected by the first and second flowmeters to calculate a ratio of the first chemical to the second chemical based on flow rate data of the first chemical and comparing the calculated ratio with a preset mixing ratio to output a control signal for controlling open rates of the flow rate control valves.

7. The apparatus as recited in claim 6, wherein the controller is a PID controller.

8. The apparatus as recited in claim 6, further comprising:
a mixing tank in which the chemicals transferred from the first and second transfer lines are temporarily stored and mixed, the mixing tank being installed at the first and second transfer lines and the main transfer line.

9. The apparatus as recited in claim 6, further comprising:
a mixer mounted on the main transfer line for mixing transferred chemicals.

10. A method for mixing chemicals transferred from at least two chemical source sections and supplying the mixture to a treating apparatus through transfer lines and a main transfer line, the method comprising:
setting a mixing ratio of at least tow chemicals;
transferring chemicals to the treating apparatus through transfer lines connected to the chemical source sections respectively;
detecting flow rates of the chemicals transferred to the transfer lines respectively; and
comparing the detected flow rate data with a preset mixing ratio of chemicals to control flow rates of the chemicals.

11. The method as recited in claim 10, wherein controlling the flow rates of the chemicals comprises:
based on a flow rate of one of the chemicals, calculating a mixing ratio of the other chemicals;
comparing the calculated mixing ratio with a preset mixing ratio; and
controlling open rates of flow rate control valves mounted on the transfer lines respectively depending on the comparing result.

12. The method as recited in claim 10, wherein controlling the flow rates of the chemicals comprises:
based on a flow rate of one of the chemicals, calculating a mixing ratio of the other chemicals;
comparing the calculated mixing ratio with a preset mixing ratio; and
controlling open rates of flow rate control valves mounted on transfer lines corresponding to the other chemicals to control flow rates of the other chemicals depending on the comparing result.

13. The method as recited in claim 10, further comprising:
draining initially transferred chemicals through the transfer line for a predetermined time.

14. The method as recited in claim 13, wherein in the detection of the chemical flow rate, a chemical flow rate is detected since the chemical is transferred.
